(19) United States
(12) Patent Application Publication
(10) Pub. No.: US 2008/0195826 A1
(43) Pub. Date: Aug. 14, 2008

(54) HIERARCHICAL STORAGE MANAGEMENT SYSTEM, HIERARCHICAL CONTROL DEVICE, INTERHIERARCHICAL FILE MIGRATION METHOD, AND RECORDING MEDIUM

(75) Inventors: Fumio Yamazaki, Kawasaki (JP); Takashi Yamaguchi, Nagoya (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/026,961

(22) Filed: Feb. 6, 2008

(30) Foreign Application Priority Data
Feb. 9, 2007 (JP) JP2007-030335

(51) Int. Cl. G06F 12/16

(52) U.S. Cl. 711/161; 711/E12.103

(57) ABSTRACT

A hierarchical storage management system and method that manages and virtualizes at least two kinds of storages with different access speeds as a primary storage and a secondary storage. The system includes a control unit configured to copy a file stored in the primary storage into the primary storage based on a determination that the file is to be migrated to be stored in the secondary storage, and a hierarchical management unit configured to transfer and store the file copied by the control unit into the primary storage to the secondary storage.

### CROSS-REFERENCE TO RELATED APPLICATIONS

This application is related to and claims priority to Japanese patent application no. 2007-30335 filed on Feb. 9, 2007, in the Japan Patent Office, and incorporated by reference herein.

### BACKGROUND

1. Field

The disclosed system, method and medium relates to hierarchical storage management that manages and virtualizes at least two kinds of storages with different access speeds as a primary storage and a secondary storage.

2. Description of the Related Art

The advancement of digitalization of information in recent years has led to digitalization of information that systems have not handled before. Thus, the amount of data to be stored is increasing rapidly, and maintenance cost has increased with the increasing amount of data to be stored. Therefore, a hierarchical storage management (HSM) system has recently been proposed that can maintain the access speed and store a large amount of data at a lower cost.

In an HSM system, at least two kinds of storages with different access speeds are prepared as a primary storage and a secondary storage. Autonomously, a more frequently accessed (for example, a more highly needed) file is moved to the primary storage with high speed, and a less frequently accessed file is moved to the secondary storage with a lower speed. Thus, the entire system can be virtualized, and an environment that allows high speed accesses can be implemented.

Typically, a storage with a high access speed is expensive compared to a storage with a low access speed. For this reason, by adopting an inexpensive storage with a low access speed as the secondary storage, the cost of the entire system can be reduced, and a large amount of data can be stored. Generally, the primary storage adopts a disk array apparatus including multiple disk devices (drivers that drive internal disks) such as hard disk devices, and the secondary storage adopts a drive device in which a DVD, a magnetic tape, etc., is automatically replaceable or an apparatus that includes the drive device. In the case of the secondary storage, a magnetic tape generally appears to be more feasible from the viewpoint of economic efficiency and high data retainment.

FIG. 5 is a diagram of a typical HSM (hierarchical storage management) system. The HSM system includes a host computer (referred to as a “ghost” hereinafter) 50 connected to a communication network and includes a disk array apparatus as a primary storage 60 and a tape library apparatus as a secondary storage 70 including multiple tape drive devices 71 which use magnetic tapes 72. A hierarchical control device 80 connected to the host computer 50, the primary storage 60, and the secondary storage 70 autonomously migrates files between the primary storage 60 and the secondary storage 70 and performs management of files between the hierarchies. The primary storage 60 and the secondary storage 70 are virtualized by the hierarchical control device 80.

The hierarchical control device 80 executes a hierarchical control program 81 to manage files between the hierarchies. A file system 51 and a connecting program 52 are installed in the host 50. The file system 51 is a program for implementing file management, and the connecting program 52 connects the hierarchical control program 81 to be executed by the hierarchical control device 80 and the file system 51.

The connecting program 52 relays information exchanges and inquiries between the file system 51 and the hierarchical control program 81. Through the relay, information relating to an access to a file is notified from the file system 51 to the hierarchical control program 81.

Based on checking the result pertaining to the information of the file access and the usage of the primary storage 60, the hierarchical control program 81 migrates a file between the hierarchies as required. When determining that that the primary storage 60 does not have a necessary or larger amount of space as a result of the check of the usage, a less frequently accessed file among the files stored in the primary storage 60 is extracted and is migrated to the secondary storage 70. The file migration between the hierarchies is performed directly by the hierarchical control device 80. The access frequency of a file can be determined based on the information provided from the file system 51 through the connecting program 52. Based on this information, the file to be returned to the primary storage 60 can also be determined among the files migrated to the secondary storage 70.

The primary storage 60 stores meta information of files (data) stored in hard disk devices in a special disk device 62 to allow file access. The file to be migrated to the secondary storage 70 among the files stored in the primary storage 60 is loaded with reference to the meta information. FIG. 5 shows a disk 61 which collectively represents disk devices to be used for storing files, that is, disk devices used by the file system 51 in the primary storage 60.

### SUMMARY

A hierarchical storage management system and method that manages and virtualizes at least two kinds of storages with different access speeds as a primary storage and a secondary storage is disclosed. The system comprises a control unit configured to copy a file stored in the primary storage into the primary storage based on a determination that the file is to be migrated to be stored in the secondary storage, and a hierarchical management unit configured to transfer and store the file copied by the control unit into the primary storage to the secondary storage.

Additional aspects and/or advantages will be set forth in part in the description which follows and, in part, will be apparent from the description, or may be learned by practice of the invention.

A method and system of managing storages with different access speeds is disclosed. The method includes, creating a copy of a file stored in a master volume in a primary storage and storing the copy of the file in a replicated volume in the primary storage, and transferring the copy of the file in the replicated volume of the primary storage to a secondary storage.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is an exemplary diagram of a hierarchical storage management system according to an embodiment of the system;

FIG. 2 is a diagram illustrating operations of components in a case where a file stored in a primary storage is to be migrated (archived) to a secondary storage;

FIG. 3 is an exemplary processing sequence diagram showing processing flows performed by components in a case where a file stored in the primary storage is to be migrated (archived) to the secondary storage;

FIG. 4 is a diagram illustrating a copying operation using One Point Copy (OPC); and

FIG. 5 is a diagram of a typical hierarchical storage management system.

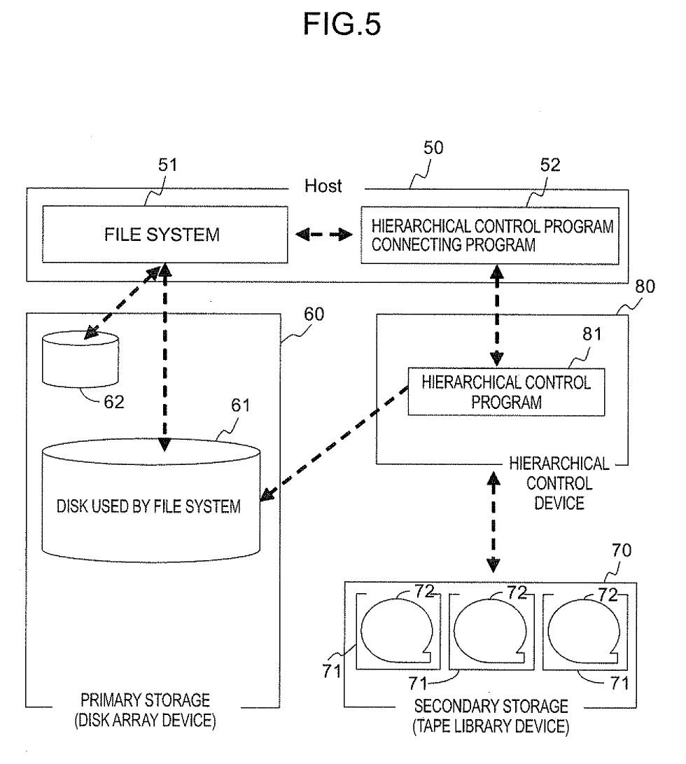

### DETAILED DESCRIPTION OF THE EMBODIMENTS

Reference will now be made in detail to the embodiments, examples of which are illustrated in the accompanying drawings, wherein like reference numerals refer to the like elements throughout. The embodiments are described below to explain the embodiment by referring to the figures.

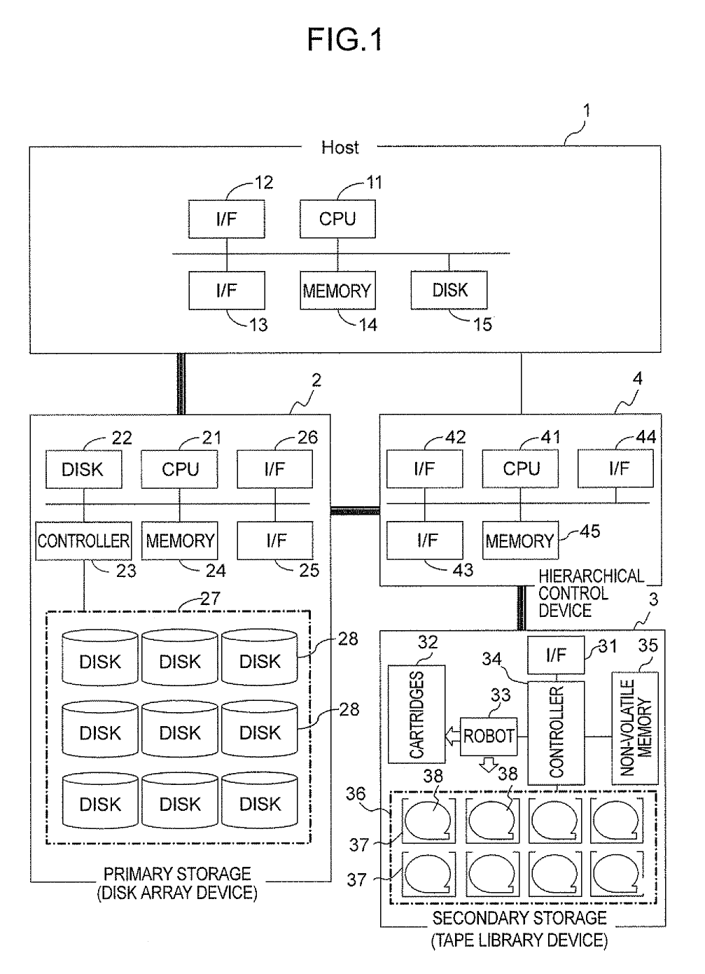

FIG. 1 illustrates a hierarchical storage management (HSM) system according to an embodiment of the system. The HSM system includes a host computer (referred to as a “host” hereinafter) 1 connected with a communication network and includes a primary storage 2 and a secondary storage 3. The primary storage 2 is a disk array apparatus, and the secondary storage 3 is a tape library device having multiple tape drive devices 37 with which magnetic tapes 38 may be used. A hierarchical control device 4 (or a hierarchical management unit) connected with the host 1, the primary storage 2, and the secondary storage 3 can autonomously migrate a file between the primary storage 2 and the secondary storage 3 and manage files between hierarchies thereof. The primary storage 2 and the secondary storage 3 can be virtualized by the hierarchical control device 4,

The host 1 is a computer which may have a configuration in which a CPU 11, two interfaces (I/Fs) 12 and 13, a memory 14 and a disk device 15 are connected via a bus. One of the two I/Fs 12 and 13 may be used for connection with the primary storage 2, and the other may be used for connection with the hierarchical control device 4. The disk device 15 stores a program to be executed by the CPU 11. The I/F used for connection with a communication network is omitted.

As illustrated in FIG. 1, the primary storage 2 has a configuration in which a CPU 21, a disk device 22, a controller 23, a memory 24 and two I/Fs 25 and 26 are connected via a bus, and a disk array 27 including multiple disk devices 28 connected to the controller 23. The disk device 22 is used for storing meta information, and a program to be executed by the CPU 21 may be stored in the memory 24, for example. One of the two I/Fs 25 and 26 is used for connection with the host 1, and the other is used for connection with the hierarchical control device 4. The controller 23 accesses the disk device 28 to be accessed in accordance with an instruction from the CPU 21.

The secondary storage 3 is configured to include an I/F 31, a cartridge section 32, a robot 33, a controller 34, a non-volatile memory 35, and a tape drive section 36 including multiple tape drive devices 37 with which magnetic tapes 38 are used.

The I/F 31 is used for connection with the hierarchical control device 4. The magnetic tape 38 may be of a cartridge type for easy handling. The cartridge section 32 includes the magnetic tapes 38 that are installable to the tape drive devices 37. The cartridge section 32 is equivalent to a storage section that can store multiple magnetic tapes 38 and one or more magnetic tapes 38 stored in the storage section. The robot 33 implements the movement of the magnetic tape 38 between the storage section and the tape drive device 37. The controller 34 controls the robot 33 to install the magnetic tape 38 to be installed to each of the tape drive devices 37 and accesses the magnetic tape 38. For performing the access, the meta information of the magnetic tape 38 is stored in the non-volatile memory 35. The meta information stored, for example, may be identification information (such as the serial number, etc.), a cumulative amount of data, and information of stored files. The magnetic tape 38 will be referred to as “cartridge” hereinafter.

The hierarchical control device 4 is a computer having a configuration in which a CPU 41, three I/Fs 42 to 44 and a memory 45 are connected via a bus. A program to be executed by the CPU 41 is stored in the memory 45. Each of the three I/Fs 42 to 44 is connected with one of the host 1, primary storage 2 and secondary storage 3.

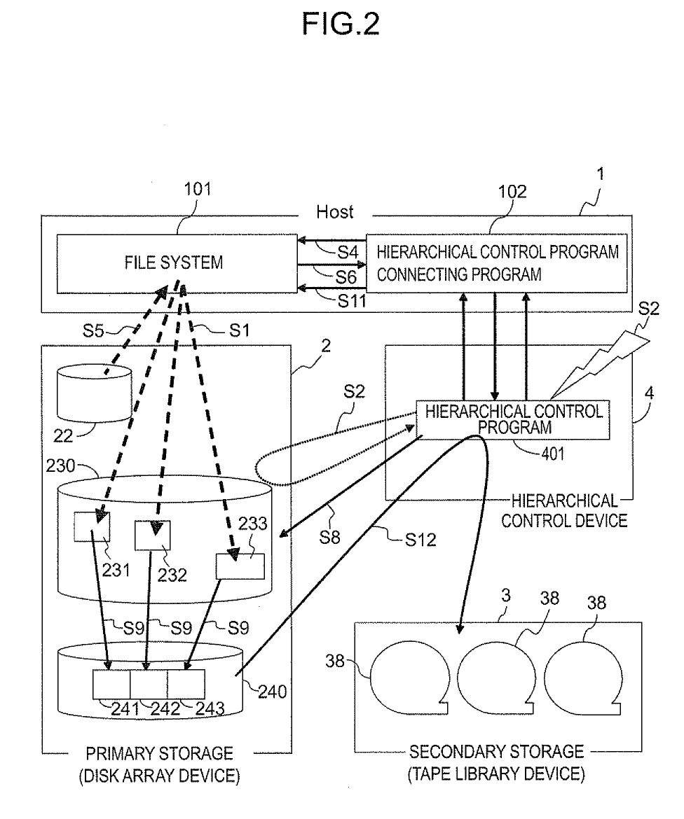

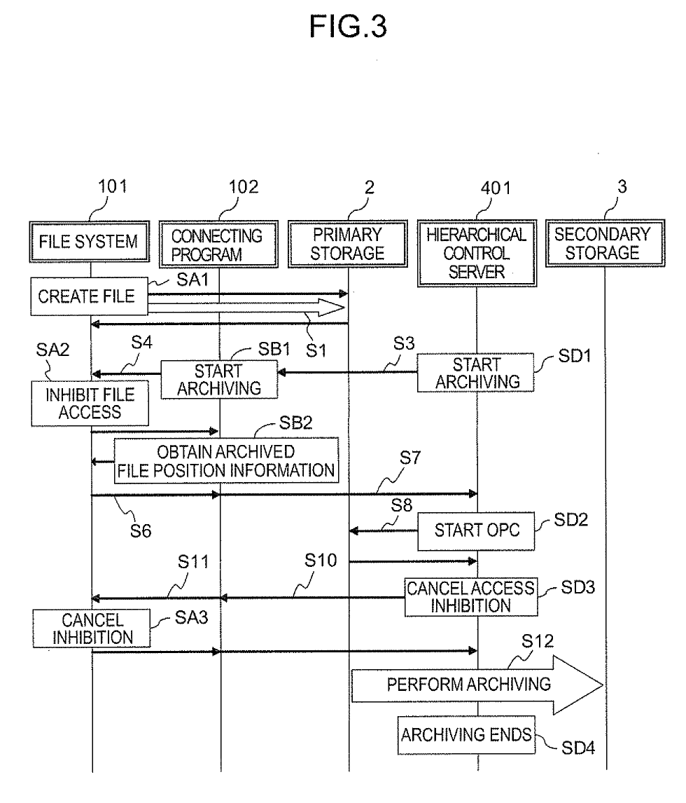

FIG. 2 illustrates operations of components in a case where a file stored in the primary storage 2 is to be migrated for archiving to the secondary storage 3. FIG. 3 illustrates a sequence of processing flows to be implemented by the components. With reference to FIGS. 2 and 3, operations to be performed by the components for implementing the archiving is described in detail below.

As shown in FIG. 2, a hierarchical control program 401 is installed in the memory 45 of the hierarchical control device 4. The hierarchical control program 401 virtualizes the primary storage 2 and the secondary storage 3 for performing file management. A file system 101 and a connecting program 102 are installed in the disk device 15 of the host 1. The file system 101 performs file management, and the connecting program 102 connects the hierarchical control program 401 to be executed by the hierarchical control device 4 and the file system 101. For ease of explanation, FIGS. 2 and 3 show the programs as components for describing operations (functions). Thus, the host 1 and the hierarchical control device 4 will be described by focusing on the installed programs.

The file system 101 creates (stores) a file on the primary storage 2 as required or needed (operation SA1 in FIG. 3). The file creation is performed by sending an instruction from the file system 101 to the primary storage 2 and transmitting data to be stored as a file (sequence S1). The file here may be placed on multiple disk devices. Meta information of the file is stored on the disk device 22 by the CPU 21. The CPU 21, upon completion of the storage of the file, notifies the file system 101 through the I/F 25 or 26.

FIG. 2 shows a disk device 230 which collectively represents disk devices used for storing files in the primary storage 2, that is, disk devices used by the file system 101. FIG. 2 further shows files 231 to 233 stored on the disk devices.

The hierarchical control program 401 obtains, as required, information relating to access to a file by the file system 101 through the connecting program 102. The hierarchical control program 401 checks usage of the primary storage 2 as required or at predetermined time intervals by inquiring about usage of the primary storage 2. Thus, based on the obtained information or a check result, hierarchical control is performed for migrating a file between the hierarchies. When determining that the primary storage 2 does not have a necessary or larger amount of space as a result of the check of the usage, a less frequently accessed file is extracted as a file to be archived among files stored in the primary storage 2, and migration to the secondary storage 3 for archiving is started. The archiving may also be started by an external command. Thus, in response to an instruction based on the check of the usage of the primary storage 2 or a command (sequence S2), the hierarchical control program 401 determines when to start archiving (operation SD1), notifies the implementation (start) of archiving through the connecting program 102 and inquires regarding position information of the file to be archived (sequence S3).

The connecting program 102 processes an instruction from the hierarchical control program 401 (operation SB1) and notifies the implementation of archiving to the file system 101 (sequence S4). The file system 101 based on the notification of the implementation of archiving, limits (inhibits) access to the file to be archived (operation SA2) and notifies the connecting program 102 that the limitation has been performed.

The connecting program 102, after receiving the notification, inquires of the file system 101 the position information of the file to be archived (operation SB2). The file system 101, in response to the inquiry, receives the meta information on the disk device 22 from the primary storage 2 (sequence S5), extracts the position information of the file to be archived from the meta information and provides the position information to the connecting program 102 (sequence S6). As a result, the position information is notified to the hierarchical control program 401 through the connecting program 102 (sequence S7).

The hierarchical control program 401, after obtaining the position information of the file to be archived, starts OPC (One Point Copy) (operation SD2) and instructs the primary storage 2 to perform OPC by handling the file indicated by the position information as one to be copied (sequence S8). Thus, a copy of the file to be archived is created on the primary storage 2.

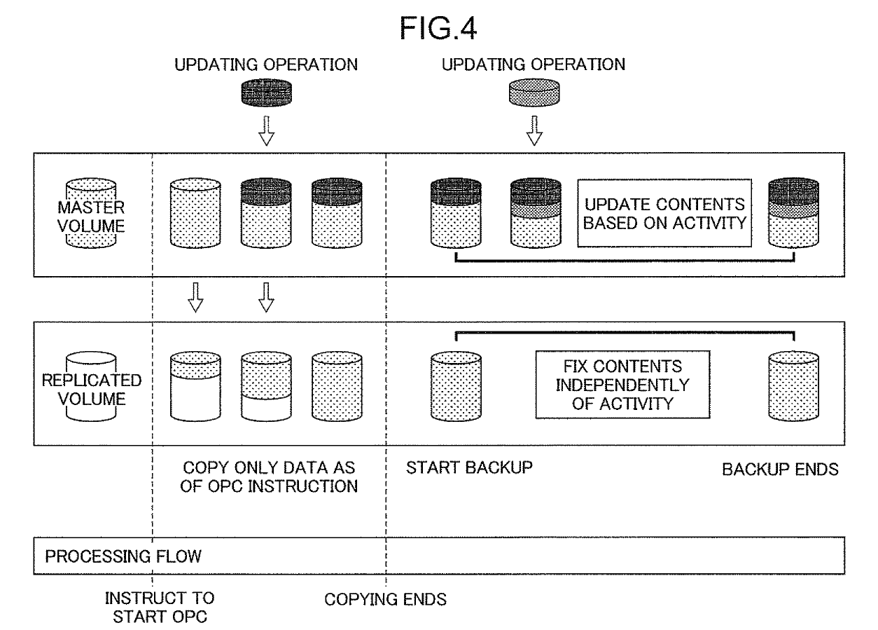

FIG. 4 illustrates a copying operation using OPC. Now, with reference to FIG. 4, the copying using OPC will be described more detail.

OPC includes copying a file (data) stored in one volume (that is, recording medium, drive device, etc.) to another volume in a short period of time. A master volume is a volume storing a file to be copied, and a replicated volume is a volume to which a file is copied.

In response to an instruction to start OPC, a file on a master volume is immediately copied to a replicated volume. The data stored in the file is copied after the file is copied. The copied data is data at the time when OPC is instructed to start. Since a file is copied onto a different volume from the original volume, the copying can be performed more quickly than the case where copying is performed on the same volume. Since the volume to which a file is copied can be handled independent of the original volume, the access limitation on the file stored in the original volume can be cancelled extremely in a short period of time. Thus, the accessibility of the file to be archived can be always maintained high.

FIG. 2 shows a destination disk 240 which includes disk devices allocated as destinations in the primary storage 2 in response to the instruction for OPC. The destination disk 240 includes files 241 to 243, which are files 231 to 233 copied onto the destination disk 240. In response to the instruction for OPC, all of files to be archived are copied to the destination disk 240.

The CPU 21 of the primary storage 2 allocates the destination disk 240 and notifies the completion of copying when a copy of the file to be archived is created on the destination disk 240, that is, before copying the data is started. After the notification, the data of the file to be copied is stored in the corresponding file on the destination disk 240 (sequence S9).

After the notification of the completion of copying from the primary storage 2, the hierarchical control program 401 notifies the completion of archiving for canceling the access limitation (inhibition) on the file to be archived (operation SD3). The notification is provided to the connecting program 102 (sequence S10) and the connecting program 102 provides the notification to the file system 101 (sequence S11). Thus, the file system 101 cancels the access limitation (operation SA3) and provides a notification that the cancellation has been performed to the connecting program 102. Based on the notification, the hierarchical control program 401 recognizes, through the connecting program 102, that the file system 101 has cancelled the access limitation. Since a file not containing data can be copied quickly, the access limitation on the file to be archived by the file system 101 can be cancelled in a short period of time.

After that, the hierarchical control program 401 loads the file (corresponding to the files 241 to 243 in FIG. 2) to be archived, which has been copied onto the destination disk 240, from the primary storage 2, transmits the file to the secondary storage 3 and performs archiving to store the file in the cartridge 38 (sequence S12). The archiving is completed when all of files to be stored in the secondary storage 3 are stored (operation SD4).

Although a disk array apparatus as the primary storage 2 and a tape library device as the secondary storage 3 have been described, other kinds of storages may be adopted. For example, the secondary storage 3 may be one in which an optical disk such as a DVD is used. Alternatively, multiple kinds of storages may be adopted as the secondary storage 3.

The archiving is performed by deploying the hierarchical control device 4 in which the hierarchical control program 401 is installed. This, for example, increases the speed of the data transfer between the primary storage 2 and the secondary storage 3. In a case where high-speed data transfer is less necessary or where a system that supports the high-speed data transfer is provided additionally, the device such as the hierarchical control device 4 may not be provided but may be included in another device such as the host 1. The hierarchical control program 401 of the hierarchical control device 4 may not be prestored in the memory 45 but may be installed by storing the program in an optical disk or a flash memory, for example. Alternatively, the hierarchical control program 401 may be distributed over a communication network. Further, a program for implementing the archiving similar to the hierarchical control program 401 may be stored in a recording medium accessible by a device connected with a communication network.

Although a few embodiments have been shown and described, it would be appreciated by those skilled in the art that changes may be made in these embodiments without departing from the principles and spirit of the invention, the scope of which is defined in the claims and their equivalents.

What is claimed is:

1. A hierarchical storage management system that manages and virtualizes at least two kinds of storages with different access speeds as a primary storage and a secondary storage, the system comprising:
a control unit configured to copy a file stored in the primary storage into the primary storage based on a determination that the file is to be migrated to be stored in the secondary storage; and
a hierarchical management unit configured to transfer and store the file copied by the control unit into the primary storage to the secondary storage.

2. The hierarchical storage management system according to claim 1, wherein the primary storage includes multiple drive devices enabling storage of the file, and the control unit creates a copy of the file to be migrated onto a different drive device from a drive device in which the file is stored.

3. The hierarchical storage management system according to claim 1, wherein the hierarchical management unit directly obtains the file copied from the primary storage and transfers the obtained file to the secondary storage.

4. The hierarchical storage management system according to claim 2, wherein the hierarchical management unit directly obtains the file copied from the primary storage and transfers the obtained file to the secondary storage.

5. A device applicable to a hierarchical storage management system that manages and virtualizes at least two kinds of storages with different access speeds as a primary storage and a secondary storage, the device controlling the file migration between the primary storage hierarchy and the secondary storage hierarchy, the device comprising:
a control unit configured to copy a file stored in the primary storage into the primary storage based on a determination that the file is to be migrated to be stored into the secondary storage; and
a hierarchical management unit configured to transfer and store the file copied by the control unit into the primary storage to the secondary storage.

6. The hierarchical control device according to claim 5, wherein the primary storage includes multiple drive devices enabling storage of the file, and the control unit creates a copy of the file to be migrated onto a different drive device from a drive device in which the file is stored.

7. The hierarchical control device according to claim 5, wherein the hierarchical management unit directly obtains the file copied from the primary storage and transfers the obtained file to the secondary storage.

8. The hierarchical control device according to claim 6, wherein the hierarchical management unit directly obtains the file copied from the primary storage and transfers the obtained file to the secondary storage.

9. An inter-hierarchical file migration method for implementing the inter-hierarchical migration of a file with a hierarchical storage management system that manages and virtualizes at least two kinds of storages with different access speeds as a primary storage and a secondary storage, the method comprising:
copying a file stored in the primary storage into the primary storage based on a determination that the file is to be migrated to be stored in the secondary storage; and
transferring and storing the file copied into the primary storage to the secondary storage.
